(19) United States
(12) Patent Application Publication
(10) Pub. No.: US 2025/0069440 A1
(43) Pub. Date: Feb. 27, 2025

(54) METHOD, SYSTEM, AND NON-TRANSITORY COMPUTER-READABLE RECORDING MEDIUM FOR SUPPORTING LABELING OF SENSOR DATA

(71) Applicant: Bodit Inc., Seoul (KR)

(72) Inventors: Min Yong Shin, Suwon (KR); Heung Jong Yoo, Seoul (KR); Yoon Chul Choi, Anyang (KR); Seong Jun Shin, Hwaseong (KR); Jin Hong Jeon, Hwaseong (KR)

(73) Assignee: Bodit Inc., Seoul (KR)

(21) Appl. No.: 18/705,109

(22) PCT Filed: Nov. 29, 2022
(86) PCT No.: PCT/KR2022/019022

§ 371 Date: Nov. 5, 2024

(30) Foreign Application Priority Data
Nov. 29, 2021 (KR) 10-2021-0167740

(51) Int. Cl. G06V 40/20; G06V 20/52; G06V 20/70

(52) U.S. Cl. CPC G06V 40/20; G06V 20/52; G06V 20/70

(57) ABSTRACT

According to one aspect of the present invention, provided is a method for supporting labeling of sensor data, comprising the steps of: acquiring sensor data to be labeled, measured by means of a sensor for a subject; and referring to the subject's behavior estimated from the sensor data to be labeled and/or first corresponding reference data, which corresponds to the sensor data to be labeled and belongs to a type differing from that of the sensor data to be labeled, thereby determining information related to labeling of the sensor data to be labeled.

### FIELD OF THE INVENTION

The present invention relates to a method, system, and non-transitory medium for computer-readable recording supporting labeling of sensor data.

### BACKGROUND

In recent years, there has been a lot of research on machine learning technology, and techniques have been introduced to efficiently monitor a specific object (e.g., a domestic animal such as a calf) using a machine learning-based behavior estimation model.

In order to monitor an object using a machine learning-based behavior estimation model, the behavior estimation model should first be well trained, which requires the use of a sufficiently large amount of high-quality training data (e.g., accurately labeled training data). Due to this requirement, the training data is generated by collecting and labeling particular data (e.g., sensor data). However, there are cases where low-quality training data is generated due to incorrect labeling caused by low judgment proficiency of labelers in the above process, or where the collected data cannot be labeled and utilized as the training data (e.g., where sensor data for an object cannot be labeled because it is difficult to check the status of the object due to the object being obscured in video data obtained by photographing the object, when the sensor data is labeled on the basis of the video data).

In this connection, the inventor(s) present a technique for acquiring labeling target sensor data measured by a sensor for an object, estimating a behavior of the object from at least one of the labeling target sensor data and first reference data that corresponds to the labeling target sensor data and is of a type different from the labeling target sensor data, and determining information on labeling of the labeling target sensor data with reference to the estimated behavior of the object, thereby minimizing the cases where sensor data collected for an object is discarded or mislabeled.

### SUMMARY OF THE INVENTION

One object of the present invention is to solve all the above-described problems in prior art.

Another object of the invention is to acquire labeling target sensor data measured by a sensor for an object, and determine information on labeling of the labeling target sensor data with reference to a behavior of the object estimated from at least one of the labeling target sensor data and first reference data that corresponds to the labeling target sensor data and is of a type different from the labeling target sensor data.

Yet another object of the invention is to minimize the cases where sensor data collected for an object is discarded or mislabeled.

The representative configurations of the invention to achieve the above objects are described below.

According to one aspect of the invention, there is provided a method comprising the steps of: acquiring labeling target sensor data measured by a sensor for an object; and determining information on labeling of the labeling target sensor data with reference to a behavior of the object estimated from at least one of the labeling target sensor data and first reference data that corresponds to the labeling target sensor data and is of a type different from the labeling target sensor data.

According to another aspect of the invention, there is provided a system comprising: a data acquisition unit configured to acquire labeling target sensor data measured by a sensor for an object; a behavior estimation unit configured to estimate a behavior of the object from at least one of the labeling target sensor data and first reference data that corresponds to the labeling target sensor data and is of a type different from the labeling target sensor data; and a labeling management unit configured to determine information on labeling of the labeling target sensor data with reference to the estimated behavior of the object.

In addition, there are further provided other methods and systems to implement the invention, as well as non-transitory computer-readable recording media having stored thereon computer programs for executing the methods.

According to the invention, it is possible to acquire labeling target sensor data measured by a sensor for an object, and determine information on labeling of the labeling target sensor data with reference to a behavior of the object estimated from at least one of the labeling target sensor data and first reference data that corresponds to the labeling target sensor data and is of a type different from the labeling target sensor data.

According to the invention, it is possible to minimize the cases where sensor data collected for an object is discarded or mislabeled.

### BRIEF DESCRIPTION OF THE DRAWINGS

FIG. 1 schematically shows the configuration of an entire system for supporting labeling of sensor data according to one embodiment of the invention.

FIG. 2 specifically shows the internal configuration of a labeling support system according to one embodiment of the invention.

FIG. 3 illustratively shows how information on labeling of labeling target sensor data is determined according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

Although the descriptions of embodiments of the invention herein are focused on monitoring behaviors of a calf, it should be understood that the invention may be applied to monitoring behaviors of any other domestic animal such as a horse or pig, and may also be applied to monitoring behaviors of a person such as a patient.

Further, it should be understood that the behavior herein does not necessarily refer to an action of an object with movement, but may also refer to a state in which the object maintains a particular posture for a predetermined period of time without changing its posture (or with very little movement).

### Configuration of the Entire System

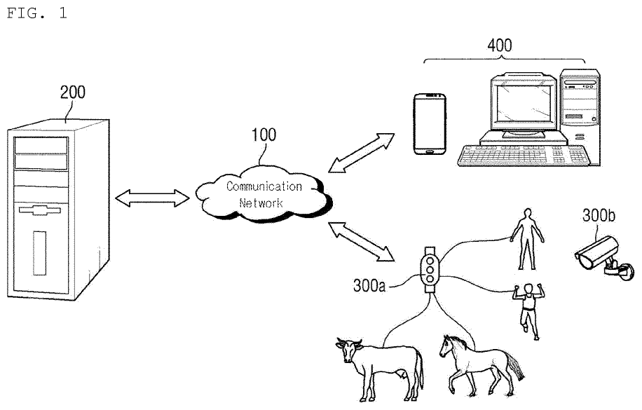

FIG. 1 schematically shows the configuration of the entire system for supporting labeling of sensor data according to one embodiment of the invention.

As shown in FIG. 1, the entire system according to one embodiment of the invention may comprise a communication network 100, a labeling support system 200, sensors 300a and 300b, and a device 400.

First, the communication network 100 according to one embodiment of the invention may be implemented regardless of communication modality such as wired and wireless communications, and may be constructed from a variety of communication networks such as local area networks (LANS), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the labeling support system 200 according to one embodiment of the invention may function to acquire labeling target sensor data measured by a sensor for an object, and determine information on labeling of the labeling target sensor data with reference to a behavior of the object estimated from at least one of the labeling target sensor data and first reference data that corresponds to the labeling target sensor data and is of a type different from the labeling target sensor data.

The configuration and functions of the labeling support system 200 according to the invention will be discussed in more detail below.

Next, the sensors 300a and 300b according to one embodiment of the invention are digital equipment capable of connecting to and then communicating with the labeling support system 200, and may consist of two or more types of sensors. For example, according to one embodiment of the invention, one sensor 300a may include a known six-axis angular velocity/acceleration sensor, and another sensor 300b may include an image sensor for photographing an object. When the sensor 300a includes a known six-axis angular velocity/acceleration sensor, the sensor 300a may measure acceleration and angular velocity (i.e., the rate of tilting in a certain direction) in the X-axis, Y-axis, and Z-axis. Further, angular acceleration may be measured together with or instead of the angular velocity.

Meanwhile, according to one embodiment of the invention, the sensors 300a and 300b may be worn on or inserted in a part (e.g., a neck) of an object (e.g., a calf), and may also be installed in a place for the object (e.g., a cattle shed for the calf). However, the types of the sensors 300a and 300b according to one embodiment of the invention and the locations or places where the sensors 300a and 300b are worn, inserted, or installed are not particularly limited, and may be diversely changed as long as the objects of the invention may be achieved. For example, the sensors 300a and 300b according to one embodiment of the invention may include a different type of sensor (e.g., a biosignal measurement sensor) other than the angular velocity/acceleration sensor and the image sensor, and may be inserted inside a body of an object (e.g., a calf).

In particular, the sensors 300a and 300b according to one embodiment of the invention may include an application (not shown) for assisting a user to be provided with the functions according to the invention from the labeling support system 200. The application may be downloaded from the labeling support system 200 or an external application distribution server (not shown). Meanwhile, the characteristics of the application may be generally similar to those of a data acquisition unit 210, a behavior estimation unit 220, a labeling management unit 230, a communication unit 240, and a control unit 250 of the labeling support system 200 to be described below. Here, at least a part of the application may be replaced with a hardware device or a firmware device that may perform a substantially equal or equivalent function, as necessary.

Next, the device 400 according to one embodiment of the invention is digital equipment capable of connecting to and then communicating with the labeling support system 200, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDAs), a web pad, and a mobile phone, may be adopted as the device 400 according to the invention.

In particular, the device 400 may include an application (not shown) for assisting a user to be provided with the functions according to the invention from the labeling support system 200. The application may be downloaded from the labeling support system 200 or an external application distribution server (not shown). Meanwhile, the characteristics of the application may be generally similar to those of the data acquisition unit 210, the behavior estimation unit 220, the labeling management unit 230, the communication unit 240, and the control unit 250 of the labeling support system 200 to be described below. Here, at least a part of the application may be replaced with a hardware device or a firmware device that may perform substantially equal or equivalent function, as necessary.

### Configuration of the Labeling Support System

Hereinafter, the internal configuration of the labeling support system 200 crucial for implementing the invention and the functions of the respective components thereof will be discussed.

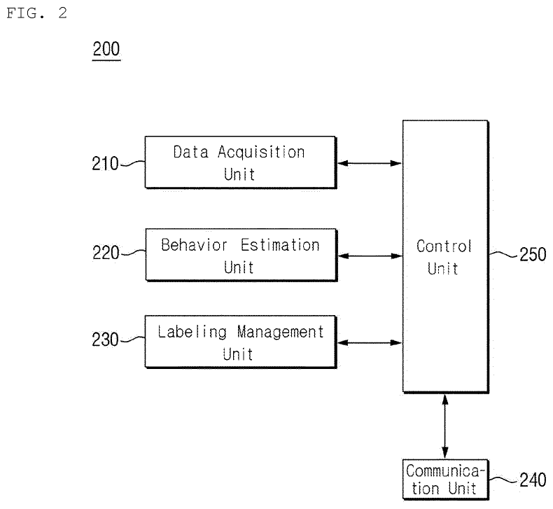

FIG. 2 specifically shows the internal configuration of the labeling support system 200 according to one embodiment of the invention.

As shown in FIG. 2, the labeling support system 200 according to one embodiment of the invention may comprise a data acquisition unit 210, a behavior estimation unit 220, a labeling management unit 230, a communication unit 240, and a control unit 250. According to one embodiment of the invention, at least some of the data acquisition unit 210, the behavior estimation unit 220, the labeling management unit 230, the communication unit 240, and the control unit 250 may be program modules to communicate with an external system (not shown). The program modules may be included in the labeling support system 200 in the form of operating systems, application program modules, or other program modules, while they may be physically stored in a variety of commonly known storage devices. Further, the program modules may also be stored in a remote storage device that may communicate with the labeling support system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the labeling support system 200 has been described as above, and it will be apparent to those skilled in the art that at least a part of the components or functions of the labeling support system 200 may be implemented in the sensors 300a and 300b, the device 400, or a server (not shown) or included in an external system (not shown), as necessary.

First, the data acquisition unit 210 according to one embodiment of the invention may function to acquire labeling target sensor data measured by a sensor 300a and/or 300b for an object.

Specifically, the sensor 300a and/or 300b according to one embodiment of the invention may measure sensor data from the object. According to one embodiment of the invention, the sensor 300a and/or 300b may be worn on or inserted in a part of the object, and the sensor data may include acceleration data and/or angular velocity data. Further, the data acquisition unit 210 according to one embodiment of the invention may acquire the measured sensor data as sensor data to be labeled, i.e., labeling target sensor data.

Meanwhile, as will be described below, the behavior estimation unit 220 according to one embodiment of the invention may estimate a behavior of the object from at least one of sensor data measured by the sensor 300a and/or 300b for the object and second reference data that corresponds to the sensor data and is of a type different from the sensor data. Further, the data acquisition unit 210 according to one embodiment of the invention may acquire the sensor data as the labeling target sensor data when the estimated behavior of the object is valid.

Specifically, the data acquisition unit 210 according to one embodiment of the invention may determine whether the behavior of the object estimated by the behavior estimation unit 220 according to one embodiment of the invention is valid. Further, the data acquisition unit 210 according to one embodiment of the invention may not acquire the sensor data measured as the object behaves (i.e., the sensor data corresponding to the behavior of the object) as the labeling target sensor data when the behavior of the object is determined to be invalid, and may acquire the sensor data measured as the object behaves as the labeling target sensor data only when the behavior of the object is valid. In addition, when the sensor data is acquired as the labeling target sensor data as above, the data acquisition unit 210 according to one embodiment of the invention may acquire the second reference data, which corresponds to the sensor data and is of a type different from the sensor data, as first reference data corresponding to the labeling target sensor data. Meanwhile, the first and second reference data according to one embodiment of the invention will be described in detail below.

For example, the data acquisition unit 210 according to one embodiment of the invention may not acquire the sensor data measured as the object behaves as the labeling target sensor data when it is determined that labeling of the sensor data corresponding to the behavior of the object is unnecessary (i.e., when the behavior of the object is determined to be invalid) (e.g., when there is no or insignificant behavior of the object, or when there is a high probability that the behavior of the object does not correspond to a predetermined type of behavior).

Next, the behavior estimation unit 220 according to one embodiment of the invention may function to estimate a behavior of the object from at least one of the labeling target sensor data and first reference data that corresponds to the labeling target sensor data and is of a type different from the labeling target sensor data.

Specifically, according to one embodiment of the invention, the first reference data corresponding to the labeling target sensor data may refer to sensor data that is sensed (e.g., measured or taken) by a sensor 300b which is of a type different from a sensor 300a for a specific object while the labeling target sensor data is measured by the sensor 300a for the specific object. Thus, according to one embodiment of the invention, the first reference data may be of a type different from the labeling target sensor data. Further, the data acquisition unit 210 according to one embodiment of the invention may acquire the sensor data sensed by the different type of sensor 300b as above as the first reference data corresponding to the labeling target sensor data.

For example, according to one embodiment of the invention, signal data measured over a particular time period by an angular velocity/acceleration sensor (which may be the sensor 300a) worn on a specific object may be the labeling target sensor data. Further, video data obtained by photographing the specific object using an image sensor (which may be the sensor 300b) over the particular time period when the labeling target sensor data is measured may be the first reference data that corresponds to the labeling target sensor data and is of a type different from the labeling target sensor data. However, the types of the labeling target sensor data and the first reference data according to one embodiment of the invention are not limited to the foregoing, and may be diversely changed as long as the objects of the invention may be achieved.

Then, the behavior estimation unit 220 according to one embodiment of the invention may estimate the behavior of the object from at least one of the labeling target sensor data and the first reference data, using a machine learning-based behavior estimation model trained on the basis of the sensor data measured by the sensor 300a for the object and second reference data that corresponds to the sensor data and is of a type different from the sensor data.

More specifically, according to one embodiment of the invention, the second reference data corresponding to the sensor data may refer to sensor data that is sensed (e.g., measured or taken) by a sensor 300b which is of a type different from a sensor 300a for a specific object while the sensor data is measured by the sensor 300a for the specific object. Thus, according to one embodiment of the invention, the second reference data may be of a type different from the sensor data. Meanwhile, according to one embodiment of the invention, the sensor data and the labeling target sensor data may be of the same type, and the first and second reference data may be of the same type.

For example, according to one embodiment of the invention, signal data measured over a particular time period by an angular velocity/acceleration sensor (which may be the sensor 300a) worn on a specific object may be the sensor data. Further, video data obtained by photographing the specific object using an image sensor (which may be the sensor 300b) over the particular time period when the sensor data is measured may be the second reference data that corresponds to the sensor data and is of a type different from the sensor data. However, the types of the sensor data and the second reference data according to one embodiment of the invention are not limited to the foregoing, and may be diversely changed as long as the objects of the invention may be achieved.

Then, according to one embodiment of the invention, the behavior estimation model may be trained on the basis pf the sensor data measured by the sensor 300a and the second reference data that corresponds to the sensor data and is of a type different from the sensor data.

For example, assuming that the second reference data includes video data, the behavior estimation unit 220 according to one embodiment of the invention may estimate the behavior of the object using a video analysis model trained to estimate the behavior of the object from the video data included in the second reference data for the object. Further, the behavior estimation unit 220 according to one embodiment of the invention may label the sensor data corresponding to the second reference data on the basis of a result of the estimation (e.g., the result of the estimation may be ruminating, nursing, or water drinking when the object is a calf). According to one embodiment of the invention, the labeling in this case may refer to preliminary labeling. Further, according to one embodiment of the invention, the behavior estimation model may be trained to estimate the behavior of the object from the sensor data measured by the sensor 300a, using the (preliminarily) labeled sensor data as training data.

Meanwhile, the behavior estimation model according to one embodiment of the invention may be implemented using a variety of known machine learning algorithms. For example, it may be implemented using an artificial neural network such as a convolutional neural network (CNN) or a recurrent neural network (RNN), but is not limited thereto.

Next, the labeling management unit 230 according to one embodiment of the invention may function to determine information on labeling of the labeling target sensor data with reference to the behavior of the object estimated by the behavior estimation unit 220 according to one embodiment of the invention.

Specifically, the behavior estimation unit 220 according to one embodiment of the invention may estimate the behavior of the object from at least one of the labeling target sensor data and the first reference data that corresponds to the labeling target sensor data and is of a type different from the labeling target sensor data, as described above. The behavior estimation unit 220 according to one embodiment of the invention may use the above-described behavior estimation model when estimating the behavior of the object from the labeling target sensor data (or the sensor data), and may use a separate analysis or estimation model (e.g., the above-described video analysis model when the first reference data includes video data) when estimating the behavior of the object from the first reference data (or the second reference data).

Then, the labeling management unit 230 according to one embodiment of the invention may determine the information on the labeling of the labeling target sensor data with reference to the estimated behavior of the object. According to one embodiment of the invention, the information on the labeling of the labeling target sensor data may include information on the result of the estimation. For example, according to one embodiment of the invention, the information on the labeling of the labeling target sensor data may include a type of the estimated behavior, accuracy or reliability of the estimation, and the like.

Further, the labeling management unit 230 according to one embodiment of the invention may label the labeling target sensor data with reference to the determined information on the labeling of the labeling target sensor data, or may provide the information on the labeling to a user (e.g., a person performing the labeling of the labeling target sensor data) together with the labeling target sensor data in a visual manner.

Meanwhile, when the behavior of the object is not estimated from the first reference data corresponding to the labeling target sensor data, the labeling management unit 230 according to one embodiment of the invention may determine the information on the labeling of the labeling target sensor data with reference to the behavior of the object estimated from the labeling target sensor data.

For example, assuming that the first reference data corresponding to the labeling target sensor data includes video data, a situation may occur in which a behavior of a specific object cannot be estimated from the first reference data because the specific object is obscured by another object or changes its posture. In this case, the labeling management unit 230 according to one embodiment of the invention may determine the information on the labeling of the labeling target sensor data with reference to the behavior of the object estimated from the labeling target sensor data by the behavior estimation unit 220 according to one embodiment of the invention. Meanwhile, according to one embodiment of the invention, the estimation herein may be performed using a behavior estimation model trained on the basis of preliminary labeling, and may be insufficiently accurate or reliable (or incomplete). Further, the labeling management unit 230 according to one embodiment of the invention may provide the determined information on the labeling to the user to ensure that the user is capable of labeling the labeling target sensor data. According to one embodiment of the invention, this allows the first reference data or the labeling target sensor data to be utilized as training data without being discarded, even when the behavior of the specific object cannot be estimated from the first reference data.

Next, the communication unit 240 according to one embodiment of the invention may function to enable data transmission/reception from/to the data acquisition unit 210, the behavior estimation unit 220, and the labeling management unit 230.

Lastly, the control unit 250 according to one embodiment of the invention may function to control data flow among the data acquisition unit 210, the behavior estimation unit 220, the labeling management unit 230, and the communication unit 240. That is, the control unit 250 according to one embodiment of the invention may control data flow into/out of the labeling support system 200 or data flow among the respective components of the labeling support system 200, such that the data acquisition unit 210, the behavior estimation unit 220, the labeling management unit 230, and the communication unit 240 may carry out their particular functions, respectively.

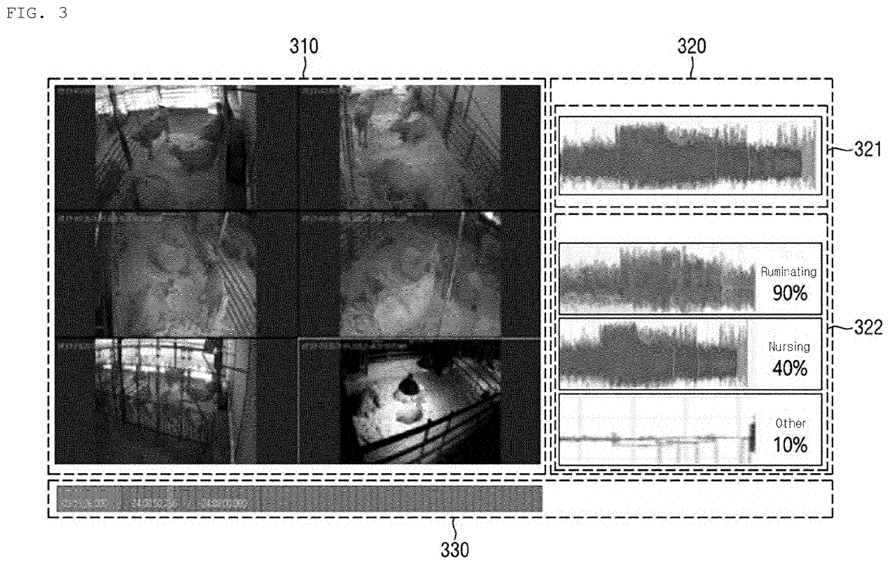

FIG. 3 illustratively shows how information on labeling of labeling target sensor data is determined according to one embodiment of the invention.

Referring to FIG. 3, according to one embodiment of the present invention, it may be assumed that the labeling target sensor data includes acceleration and/or angular velocity data, and the first reference data includes video data. Hereinafter, it will be illustrated how information on labeling of the labeling target sensor data is determined assuming the foregoing.

First, the data acquisition unit 210 according to one embodiment of the invention may function to acquire labeling target sensor data 321 measured by an angular velocity/acceleration sensor 300a for an object (e.g., calf or cow). Further, the data acquisition unit 210 according to one embodiment of the invention may acquire first reference data 310 corresponding to the labeling target sensor data 321. The labeling target sensor data 321 and the corresponding first reference data 310 may be measured or taken at the same time (330), and the labeling management unit 230 according to one embodiment of the invention may provide such information or data to a user in a visual manner (310, 320, and 330).

Here, according to one embodiment of the invention, the labeling target sensor data 321 and the corresponding first reference data 310 may be acquired only when there is movement of the object (e.g., calf or cow) (i.e., when the behavior of the object is valid). According to one embodiment of the invention, this may eliminate the inefficiency of the user having to replay all videos taken to label the labeling target sensor data 321.

Then, the behavior estimation unit 220 according to one embodiment of the invention may estimate a behavior of the object (e.g., calf or cow) from at least one of the labeling target sensor data 321 and the corresponding first reference data 310. Further, the labeling management unit 230 according to one embodiment of the invention may determine information 322 on labeling of the labeling target sensor data 321 with reference to the estimated behavior of the object, and may provide the information 322 to the user in a visual manner.

Here, when the behavior of the object (e.g., calf or cow) is not estimated from the first reference data 310 by the behavior estimation unit 220 according to one embodiment of the invention, the labeling management unit 230 according to one embodiment of the invention may determine the information 322 on the labeling of the labeling target sensor data 321 with reference to the behavior of the object (e.g., calf or cow) estimated from the labeling target sensor data 321 (such estimation may be incomplete or insufficiently accurate or reliable).

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A method for supporting labeling of sensor data, the method comprising the steps of:
acquiring labeling target sensor data measured by a sensor for an object; and
determining information on labeling of the labeling target sensor data with reference to a behavior of the object estimated from at least one of the labeling target sensor data and first reference data that corresponds to the labeling target sensor data and is of a type different from the labeling target sensor data.

2. The method of claim 1, wherein in the acquiring step, the behavior of the object is estimated from at least one of sensor data measured by the sensor and second reference data that corresponds to the sensor data and is of a type different from the sensor data, and the sensor data is acquired as the labeling target sensor data when the estimated behavior of the object is valid.

3. The method of claim 1, wherein in the determining step, the behavior of the object is estimated using a machine learning-based behavior estimation model trained on the basis of sensor data measured by the sensor and second reference data that corresponds to the sensor data and is of a type different from the sensor data.

4. The method of claim 1, wherein in the determining step, when the behavior of the object is not estimated from the first reference data, the information on the labeling of the labeling target sensor data is determined with reference to the behavior of the object estimated from the labeling target sensor data.

5. The method of claim 4, wherein the first reference data includes video data for the object, and in the determining step, the behavior of the object is not estimated as the object is obscured by another object or the object changes its posture.

6. The method of claim 4, further comprising the step of:
when the behavior of the object is not estimated from the first reference data, providing the determined information on the labeling to a user to ensure the user is capable of labeling the labeling target sensor data.

7. A non-transitory computer-readable recording medium having stored thereon a computer program for executing the method of claim 1.

8. A system for supporting labeling of sensor data, the system comprising:
a data acquisition unit configured to acquire labeling target sensor data measured by a sensor for an object;
a behavior estimation unit configured to estimate a behavior of the object from at least one of the labeling target sensor data and first reference data that corresponds to the labeling target sensor data and is of a type different from the labeling target sensor data; and
a labeling management unit configured to determine information on labeling of the labeling target sensor data with reference to the estimated behavior of the object.

9. The method of claim 8, wherein the behavior estimation unit is configured to estimate the behavior of the object from at least one of sensor data measured by the sensor and second reference data that corresponds to the sensor data and is of a type different from the sensor data, and the data acquisition unit is configured to acquire the sensor data as the labeling target sensor data when the estimated behavior of the object is valid.

10. The system of claim 8, wherein the behavior estimation unit is configured to estimate the behavior of the object using a machine learning-based behavior estimation model trained on the basis of sensor data measured by the sensor and second reference data that corresponds to the sensor data and is of a type different from the sensor data.

11. The system of claim 8, wherein the labeling management unit is configured to, when the behavior of the object is not estimated from the first reference data, determine the information on the labeling of the labeling target sensor data with reference to the behavior of the object estimated from the labeling target sensor data.

12. The system of claim 11, wherein the first reference data includes video data for the object, and the behavior of the object is not estimated as the object is obscured by another object or the object changes its posture.

13. The system of claim 11, wherein the labeling management unit is configured to, when the behavior of the object is not estimated from the first reference data, provide the determined information on the labeling to a user to ensure the user is capable of labeling the labeling target sensor data.
